(19) United States
(12) Patent Application Publication
(10) Pub. No.: US 2007/0086377 A1
(43) Pub. Date: Apr. 19, 2007

(54) System and method for providing graphical or textual displays of information relating to voice communications in a wireless communication network

(76) Inventor: Pertti O. Alapuranen, Deltona, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/251,675

(22) Filed: Oct. 17, 2005

(51) Int. Cl. H04Q 7/00; H04L 12/56

(52) U.S. Cl. 370/329; 370/400

(57) ABSTRACT

A system and method for supplementing voice transmissions between at least two devices (300) in a wireless network (100), in particular, a wireless multihopping network, with user information pertaining to a transmitting user. The system and method employ a device (300) capable of sending and receiving voice transmissions, which is programmable with user information that defines a user of the device (300), such that the device (300) combines voice transmissions from the device (300) with the programmed user information into a transmission for receipt by other devices (300) in the network (300).

### FIELD OF THE INVENTION

The present invention relates to wireless ad-hoc peer-to-peer communication networks, and more particularly to a system and method for providing graphical or textual displays of information relating to voice communications occurring in a wireless communication network.

### BACKGROUND

In recent years, a type of mobile communications network known as an “ad-hoc” network has been developed. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet. Details of these advanced types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, now U.S. Pat. No. 6,807,165, and in U.S. patent application Ser. No. 09/815,164 entitled “Prioritized-Routing for an Ad-Hoc, Peer-to-Peer, Mobile Radio Access System”, filed on Mar. 22, 2001, now U.S. Pat. No. 6,873,839, the entire content of each being incorporated herein by reference.

Ad-hoc networks for use in emergency response scenarios are also being developed which, in addition to enabling mobile nodes to communicate with each other as in a conventional ad-hoc network, further enable the mobile nodes to access a fixed network and thus communicate with other mobile nodes. Details of these advanced types of ad-hoc networks are described, for example in U.S. patent application Ser. No. 10/863,069, entitled “A Method to Provide a Measure of Link Reliability to a Routing Protocol in an Ad Hoc Wireless Network”, filed on Jun. 7, 2004, in U.S. patent application Ser. No. 10/863,534, entitled, “System and Method for Characterizing the Quality of a Link Wireless Network”, filed on Jun. 7, 2004, in U.S. Patent Application Serial No. 2002-541905, entitled “Ad hoc Peer to Peer Mobile Radio Access System Interfaced to the PSTN and Cellular Networks”, in U.S. patent application Ser. No. 10/799,090, entitled “A Real-Time System and Method for Improving the Accuracy of the Computed Location of Mobile Subscribers in a Wireless Ad-Hoc Network Using a Low Speed Central Processing Unit”, filed on Mar. 12, 2004, and in U.S. patent application Ser. No. 10/799,398, entitled “A System and Method for Analyzing the Precision of Geo-Location Services in a Wireless Network Terminal”, filed on Mar. 12, 2004, the entire content of each being incorporated herein by reference.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example ad-hoc wireless communications network including a plurality of nodes employing a system and method in accordance with an embodiment of the present invention; and

FIG. 2 is a block diagram illustrating an example of a mobile node employed in the network shown in FIG. 1;

FIG. 3 is a block diagram of a communication employing a node as shown in FIG. 2, and further comprising a display that is capable of displaying both textual and graphical information;

FIG. 4 is a flowchart illustrating an example of operations performed in accordance with an embodiment of the present invention for adding data to a voice signal; and

FIG. 5 is a flowchart illustrating an example of operations performed for displaying source information in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a system and method for providing graphical or textual displays of information relating to voice communications occurring in a wireless communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a system and method for providing graphical or textual displays of information relating to voice communications occurring in a wireless communication network described herein. The non-processor circuits may include, but are not limited to, a radio receiver, a radio transmitter, signal drivers, clock circuits, power source circuits, and user input devices. As such, these functions may be interpreted as steps of a method for providing graphical or textual displays of information relating to voice communications occurring in a wireless communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

As discussed in detail below, the present invention provides a system and method for supplementing voice transmissions between at least two devices in a wireless network with user information pertaining to a transmitting user. The system and method employ a first device capable of sending and receiving voice transmissions, which is programmable with user information that defines a user of the device, such that the device combines voice transmissions from the device with the programmed user information into a voice-over-data transmission. The system and method further employ a second device that receives the voice-over-data transmission, and which informs a second user as to the user information of the first user from whom the voice transmission is being received.

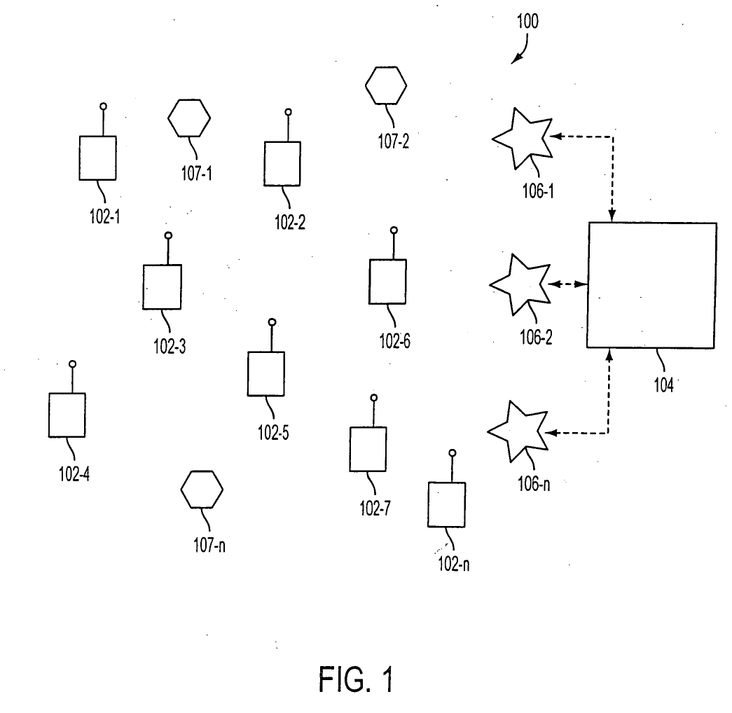

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or fixed routers 107) for routing data packets between other nodes 102, 106 or 107. It is noted that for purposes of this discussion, the nodes discussed above can be collectively referred to as “nodes 102, 106 and 107”, or simply “nodes”.

As can be appreciated by one skilled in the art, the nodes 102, 106 and 107 are capable of communicating with each other directly, or via one or more other nodes 102, 106 or 107 operating as a router or routers for packets being sent between nodes, as described in U.S. patent application Ser. No. 09/897,790, and in U.S. Pat. Nos. 6,807,165 and 6,873,839, referenced above.

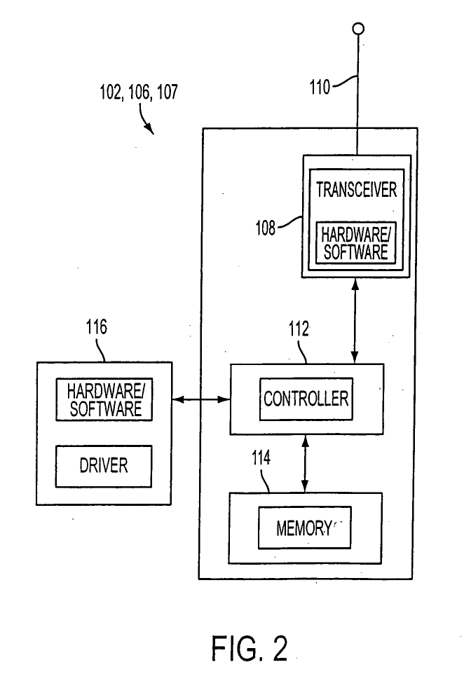

As shown in FIG. 2, each node 102, 106 and 107 includes a transceiver, or modem 108, which is coupled to an antenna 110 and is capable of receiving and transmitting signals, such as packetized signals, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM) that is capable of storing, among other things, routing information pertaining to itself and other nodes in the network 100. As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included.

As discussed above, there is a need for improved systems and methods for use in emergency response contexts that have voice communication information capabilities, or other environments such as conventions, airports, terminals, and so on, in which it is beneficial to identify the source of the voice communication. In an emergency situation example, following large incidents, emergency personnel typically gather at a common area from multiple jurisdictions, in a joint effort to remedy the situation. In these types of situations, it is beneficial to attach information to voice communications, in order to assist in identifying the source of a voice communication in real-time or near real-time, and to assess the relevancy of the information.

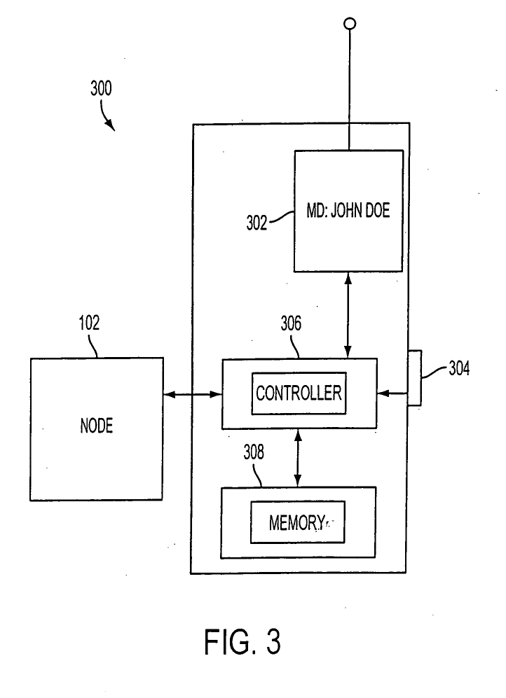

As can be appreciated by one skilled in the art, in voice-over-packet systems, two or more digital voice signals can be combined to form a single signal that comprises the multiple digital voice signals. This combining can be done in a digital audio mixer or voice mixer. A voice mixer, for example, determines the source of the signal from the characteristics of the signal itself or, for example, from information provided by a “push to talk” operation of the device making the transmission. As discussed below, this information can be used to selectively add digital information pertaining to the audio source to the packet stream. The information can be added, for example, to the header of the packets including the voice communication information, or to any other suitable portion of the packet. In order to combine the voices of two users in conventional systems, signals from the two users were routed to a single point (e.g., base station or similar device) where the voices of the two users were combined and then transmitted as a combined signal. However, using the system and method according to the present invention, effectively all simultaneously or otherwise concurrently transmitted signals, such voice signals produced by a digital push-to-talk radio system of a communication device 300 as shown in FIG. 3 that employs a node 102, can be combined at any of the nodes 102, 106 or 107 that receive the simultaneously transmitted signals, and at any of the communication devices 300 employing one of the nodes. The voice signals are digital, compressed, and packetized, and multiple voice signals can be decompressed to a suitable format that allows the signals to be combined. After the combination, the combined signal can be compressed back to a digital format that is suitable for transmission. A distributed digital audio or voice mixer that operates, for example, in a transceiver 108 and/or controller 112 of a receiving node 102, 106 or 107 can add at least one control signal that identifies the original signals that were added together to produce the combined signal.

While voice communications are generally separate from data, the present invention further provides a system and method for adding textual information to voice communications. In particular, for example, textual information pertaining to the name and rank of a person originating a voice communication can be added to the voice signal by the node (e.g., node 102) and/or its associated host 116 that the person uses to transmit the signal, and then displayed in a handheld unit display of an individual receiving a voice communication, to identify the source of the voice communications in a multi-hop packet system. Textual information can contain, for example:
1) The name of the person talking;
2) The unit/jurisdiction and/or any other information suitable for identification;
3) The experience and/or role of the person talking, for example, the person may be a medical doctor; and
4) Any other relevant information.

A communication device 300 as shown in FIG. 3 preferably has a display 302 that is capable of displaying both textual and graphical information, and can be a handheld device or have any suitable shape and size. When the source of the received information changes, the voice source information displayed on the display 302 of the communication device 300 changes in real-time or within a reasonable period (e.g., a few seconds) after the new information is received. The display 302 of the communication device 300 can have any suitable display format, such as, for example, a single line, a multi line, and/or a graphical display with any suitable tags and values. Tags, in this regard, can represent the data type in any suitable format, such as, for example, textual and/or graphical format. Moreover, the display 302 may scroll when presenting multiple tags and values. The examples include “MD:John Doe” (wherein “MD” means medical doctor) and “FC:John Doe” (wherein “FC” means “fire chief”).

A communication device 300 of the system and method according to the present invention can further comprise a programmable mute button 304 or function. For example, the communication device 300 can be programmed (e.g., the controller 112 of the node 102 employed in the communication device 300) to play communications of certain individuals only, or to be activated only if the attached information matches some criteria. For example, a communication device 300 that is receiving communications from a large group of people can be configured to play only those communications of the people who are trained physicians or trained commanders. As further shown, the communication device 300 further includes a controller 306 for controlling the communication device 300 to perform the above operations, and a memory 308 that can include the categories of people and the preferences or criteria by which they are displayed, and can be accessed by the controller 306 so that the appropriate communications are played and their respective information displayed.

As can be appreciated by one skilled in the art, a communication device 300 can be programmed in any suitable manner. For example, the appropriate information can be programmed into the communication device 300 through use of radio frequency identification (RF-ID) tags, memory cards or similar devices with unique information identifying the user of the communication device 300. Also, the information can be programmed through use of a keyboard associated with the host 116 of a node 102 employed in the communication device 300. After programming, the communication device 300 can include information as discussed above in the voice or other communications transmitted from the communication device 300 using a distributed audio mixer, for example, as discussed above in cooperation with a push-to-talk feature. That information can thus be displayed in textual or graphic form on the display 302 of a communication device 300 that receives the voice communication and information.

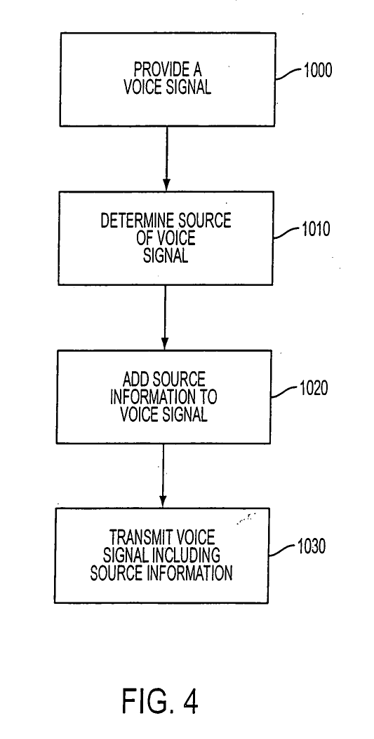

Accordingly, as can be appreciated from the above and as shown in the flowchart in FIG. 4, the communication device 300 can provide a voice signal in step 1000, such as that generated by a user of the communication device speaking into a microphone, for example, of the communication device. In step 1010, the communication device 300 determines the source of the voice signal, for example, by information programmed into the memory 308 that indicates the identity of the authorized user of that communication device 300 (e.g., medical doctor John Doe). In step 1020, the communication device 300 adds the textual information identifying the source of the communication to the voice signal in the manner discussed above. In step 1030, the communication device 300 then communicates the voice signal including the source information, for example, via its associated node 102 as shown in FIG. 3.

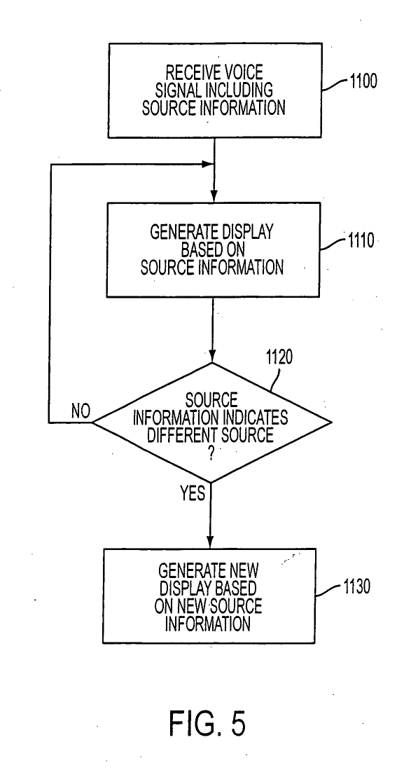

As discussed above and as shown in the flowchart of FIG. 5, another communication device 300 can receive the voice signal including the source information in step 1100. In step 1110, that communication device 300 can generate a display as shown, for example, in FIG. 3 based on the information. As long as the source information indicates the same source, the communication device continues to generate the display. However, as indicated in step 1120, if the source information in a received voice signal indicates a different source of the voice communication, the communication device 300 generates a different display in step 1130 based on the new source information.

In another embodiment of the present invention, the communication device 300 is capable of switching between multiple packetized audio streams, based on priorities. The ability of the system to switch multiple packetized audio streams is based, for example, on the high data rate of the network 100. In particular, for example, a controller 112 in a node 102 employed in a communication device 300 receiving multiple digital voice packet streams can select the streams sent to a digital audio mixer in the transceiver 108, for example, of the node 102 in the communication device 300 based on predetermined rules which are preprogrammed and read from a memory device (e.g., memory 114), or which are entered into the communication device 300 manually. Each digital voice stream, in this regard, can be converted into a format suitable for combining and then the result is transformed into an audio signal.

For example, an audio stream with pre-selected filtering parameters can be selected by a user of the communication device 300. The communication device 300 can thus automatically select packet streams based on digital information attached to them. Example such priorities include:
1) commander
2) team members
3) medical personnel
   These priorities can depend on the task that the user of the communication device 300 is performing. This capability of the communication device 300 allows distributed voice mixing in the multihopping peer-to-peer network 100 without the need of a centralized voice mixer as in conventional systems. An example is a situation in which a communication device 300 combines digital audio packet streams and then selects an important audio packet stream, such as from a fire chief or police chief, for playing so that the user can hear that important message. In this example, this later-received, high priority packet stream is played and less important streams are not played. Additionally, information can be displayed which identifies the talker, e.g., as the fire or police chief, as well as their name or unit.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A wireless multihopping network, comprising:
a first device, adapted to wirelessly communicate in the wireless multihopping network, and further adapted to include information pertaining to a user of the first device in a voice communication and to transmit the voice communication including the information; and
a second device, adapted to wirelessly communicate in the wireless multihopping network, and further adapted to receive the voice communication from the first device, and to provide information pertaining to the user of the first device.

2. A wireless multihopping network as claimed in claim 1, wherein:
the second device comprises a display that displays information based on the information in the received voice communication to provide information pertaining to the user of the first device.

3. A wireless multihopping network as claimed in claim 1, wherein:
the first device is adapted to transmit the voice communication as a voice-over-data transmission.

4. A wireless multihopping network as claimed in claim 1, wherein:
the first device is adapted to transmit the voice communication as a packetized signal.

5. A wireless multihopping network as claimed in claim 1, wherein:
the first device further comprises a memory, adapted to store the information pertaining to the user of the first device, such that the first device access the memory to include the information in the voice communication.

6. A wireless multihopping network as claimed in claim 1, wherein:
the first device comprises a push-to-talk feature, and the first device is adapted to include the information in the voice communication in response to activation of the push-to-talk feature.

7. A wireless multihopping network as claimed in claim 1, wherein:
the first device is further adapted to combine at least two different voice communications into a single combined voice communication; and
the second device is further adapted to receive the single combined voice communication and provide information as to the respective users of the devices that transmitted the different voice communications.

8. A wireless multihopping network as claimed in claim 1, wherein:
the second device is further adapted to receive a plurality of voice communications from the first device and at least one other device, and is adapted to audibly communicate certain of the voice communications while refraining from audibly communicating other of the voice communications.

9. A method for operating a wireless multihopping network, the method comprising:
operating a first device to include information pertaining to a user of the first device in a voice communication, and to transmit the voice communication including the information over the wireless multihopping network; and
operating a second device to receive the voice communication from the first device, and to provide information pertaining to the user of the first device.

10. A method as claimed in claim 9, wherein:
the second device operating step comprises operating a display of the second device to display information based on the information in the received voice communication to provide the information pertaining to the user of the first device.

11. A method as claimed in claim 9, wherein:
the first device operating step comprises operating the first device to transmit the voice communication as a voice-over-data transmission.

12. A method as claimed in claim 9, wherein:
the first device operating step comprises operating the first device to transmit the voice communication as a packetized signal.

13. A method as claimed in claim 9, further comprising:
storing the information pertaining to the user of the first device in a memory of the first device; and
wherein the first device operating step comprises operating the first device to access the memory to include the information in the voice communication.

14. A method as claimed in claim 9, wherein:
the first device comprises a push-to-talk feature; and
the first device operating step comprises operating the first device to include the information in the voice communication in response to activation of the push-to-talk feature.

15. A method as claimed in claim 9, further comprising:
operating the first device to combine at least two different voice communications into a single combined voice communication; and
operating the second device to receive the single combined voice communication and provide information as to the respective users of the devices that transmitted the different voice communications.

16. A method as claimed in claim 9, further comprising:
operating the second device to receive a plurality of voice communications from the first device and at least one other device, and to audibly communicate certain of the voice communications while refraining from audibly communicating other of the voice communications.

17. A device, adapted for communication in a wireless multihopping network, the device comprising:
a transceiver; and
a controller, adapted to include information pertaining to a user of the first device in a voice communication and to control the transceiver to transmit the voice communication including the information wirelessly over the wireless multihopping network.

18. A device as claimed in claim 17, further comprising:
a memory, adapted to store the information pertaining to the user of the first device, and
wherein the controller is further adapted to access the memory to include the information in the voice communication.

19. A device as claimed in claim 17, further comprising:
a push-to-talk feature; and
wherein the controller is adapted to include the information in the voice communication in response to activation of the push-to-talk feature.

20. A device as claimed in claim 17, wherein:
the transceiver is adapted to transmit the voice communication as at least one of a voice-over-data transmission and a packetized signal.
